(19) United States
(12) Patent Application Publication
(10) Pub. No.: US 2025/0274306 A1
(43) Pub. Date: Aug. 28, 2025

(54) SYSTEMS AND METHODS FOR REMOTE SURVEILLANCE IN AN INTERNET OF THINGS (IOT) ENVIRONMENT

(71) Applicant: SAMSUNG ELECTRONICS CO., LTD., Suwon-si (KR)

(72) Inventors: Siba Prasad Samal, Bengaluru (IN); Ankit Jain, Bengaluru (IN); Raveendra Karu, Bengaluru (IN); Kshitij Patel, Bengaluru (IN); Hrithik Mohan Puchakayala, Bengaluru (IN); Kochiganti S P L Harsha Kasyap, Bengaluru (IN); Adarsh Vasudhesh, Bengaluru (IN)

(73) Assignee: SAMSUNG ELECTRONICS CO., LTD., Suwon-si (KR)

(21) Appl. No.: 19/030,124

(22) Filed: Jan. 17, 2025

Related U.S. Application Data
(63) Continuation of application No. PCT/KR2024/020213, filed on Dec. 10, 2024.

(30) Foreign Application Priority Data
Feb. 28, 2024 (IN) 202441014450

(51) Int. Cl. H04L 12/28; G16Y 20/10; G16Y 40/35

(52) U.S. Cl. CPC H04L 12/2827; G16Y 20/10; G16Y 40/35

(57) ABSTRACT

A method and system for remote surveillance in an IoT environment is disclosed. The method includes detecting one or more trigger conditions associated with occurrence of an event at a location within the IoT environment, wherein the one or more trigger conditions are associated with an event criteria; detecting one or more entities associated with the event that are present at the location using one or more non-imaging sensors; determining operational states of one or more IoT devices at the location at a time of detecting the one or more entities; determining whether the one or more trigger conditions is a false trigger condition based on a correlation of the one or more entities and the operational states of the one or more IoT devices; and modifying the event criteria based on a determination that the one or more trigger conditions is the false trigger condition.

### CROSS-REFERENCES TO RELATED APPLICATIONS

This application is a continuation of International Application No. PCT/KR2024/020213, filed on Dec. 10, 2024, filed in the Korean Intellectual Property Office, which claims priority from Indian Patent Application No. 202441014450 filed on Feb. 28, 2024, with the Indian Intellectual Property Office, the disclosures of which are incorporated herein in their entireties.

### TECHNICAL FIELD

The present invention generally relates to surveillance systems, and more particularly, to system and method for remote surveillance in an Internet of Things (IoT) environment.

### BACKGROUND

In recent years, with an increase in connected devices and smart-homes, there has also been an increase in home monitoring systems. The home monitoring systems are aimed to enhance the safety and well-being of users. For instance, a parent may set up the home monitoring system in their house to remotely monitor a child while the parent is away from home. Thus, users are empowered to engage in real-time observation and supervision.

In home monitoring systems, a combination of sensors are used. In some cases, cameras may be used for monitoring various locations within an area (such as, a house). However, cameras are difficult to install at each and every location within the area. Further, when users do not have cameras installed, then it becomes difficult for the users to monitor the locations.

For example, an elderly person or a child or a pet may be present at a location where cameras are not installed. In related techniques, a motion alert may be generated, and the user may be notified regarding the alert. However, the user is unable to determine if the alert is a false alarm or not. For example, an alert may be generated due to movement of the pet or the elderly person at the location where cameras are not installed. Further, the user may not be able to visualize the location and why the alert has been generated. That is, in related techniques, textual alerts are generated which are not intuitive and the user does not get an accurate visualization. Moreover, there is an increased number of false alerts in related techniques. As a result, cognitive load is increased and user engagement is reduced significantly.

### SUMMARY

According to one embodiment of the present disclosure, a method for remote surveillance in an Internet of Things (IoT) environment is disclosed. The method includes detecting one or more trigger conditions associated with occurrence of an event at a location within the IoT environment, wherein the one or more trigger conditions are associated with an event criteria; detecting one or more entities associated with the event that are present at the location using one or more non-imaging sensors; determining operational states of one or more IoT devices at the location at a time of detecting the one or more entities; determining whether the one or more trigger conditions is a false trigger condition based on a correlation of the one or more entities and the operational states of the one or more IoT devices; and modifying the event criteria based on a determination that the one or more trigger conditions is the false trigger condition.

According to another embodiment of the present disclosure, a system for remote surveillance in an Internet of Things (IoT) environment is disclosed. The remote surveillance system comprises memory and at least one processor communicably coupled to the memory. The at least one processor is configured to detect one or more trigger conditions associated with occurrence of an event at a location within the IoT environment, wherein the one or more trigger conditions are associated with an event criteria; detect one or more entities associated with the event that are present at the location using one or more non-imaging sensors; determine operational states of one or more IoT devices at the location at a time of detecting the one or more entities; determine whether the one or more trigger conditions is a false trigger condition based on a correlation of the one or more entities and the operational states of the one or more IoT devices; and modify the event criteria based on a determination that the one or more trigger conditions is the false trigger condition.

According to another embodiment of the present disclosure, a method for remote surveillance in an Internet of Things (IoT) environment is disclosed. The method includes detecting one or more trigger conditions associated with occurrence of an event at a location within the IoT environment, wherein the one or more trigger conditions are associated with an event criteria; detecting one or more entities associated with the event that are present at the location using one or more non-imaging sensors; determining operational states of one or more IoT devices at the location at a time of detecting the one or more entities; determining whether the one or more trigger conditions is a false trigger condition or a real trigger condition based on a correlation of the one or more entities and the operational states of the one or more IoT devices; and based on a determination that the one or more trigger conditions is the real trigger condition, generating a virtual visual representation of the location within with the IoT environment, the virtual visual representation graphically indicating the occurrence of the event at the location.

According to another embodiment of the present disclosure, a non-transitory computer readable medium storing instructions is disclosed. The instructions causing at least one processor to detect one or more trigger conditions associated with occurrence of an event at a location within the IoT environment, wherein the one or more trigger conditions are associated with an event criteria; detect one or more entities associated with the event that are present at the location using one or more non-imaging sensors; determine operational states of one or more IoT devices at the location at a time of detecting the one or more entities; determine whether the one or more trigger conditions is a false trigger condition or a real trigger condition based on a correlation of the one or more entities and the operational states of the one or more IoT devices; and based on a determination that the one or more trigger conditions is the real trigger condition, generate a virtual visual representation of the location within with the IoT environment, the virtual visual representation graphically indicating the occurrence of the event at the location.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a home monitoring process;

FIG. 2 illustrates an exemplary representation of an Internet of Things (IoT) environment, according to an embodiment of the present disclosure;

FIG. 3 illustrates a block diagram of the system for monitoring the IoT environment, according to an embodiment of the present disclosure;

FIG. 4 illustrates a process flow to depict an operation of the entity detection module, according to an embodiment of the present disclosure;

FIG. 5 illustrates an exemplary visual representation generated by the system, according to an embodiment of the present disclosure;

FIG. 6 illustrates an exemplary flow chart associated with remote surveillance of the IoT environment, according to an embodiment of the present disclosure; and

FIGS. 7-8 illustrate exemplary flow charts of processes for remote surveillance in an IoT environment, according to various embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

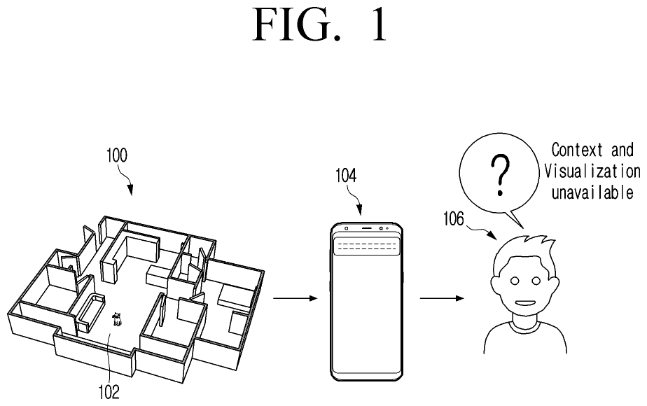

Referring to FIG. 1, a home monitoring process is depicted. As seen in FIG. 1, an area 100 may be an area in which motion and audio may be detected at the location 102. The motion may be, for instance, due to movement of the cat while the audio may be due to meowing of the cat present at the location 102. As a result of the motion and audio detection, an alert is generated and shown to a remote user on the user device 104. As an example, a notification may be sent to the user. However, the user 106 may not have detailed context and visualization of the location 102. The user 106 may be unaware why the alert is generated.

As another example, an elderly person may be drinking water in a glass at a particular location. The glass may break causing a sound to be emitted. A fall detection alert may be sent to the user, however, the user may not be sure whether the fall detection alert is due to a mishap with the elderly person or due to some other reason. The use misses context and visualization.

Accordingly, there is a need for systems and methods that overcome at least some of the above-mentioned limitations.

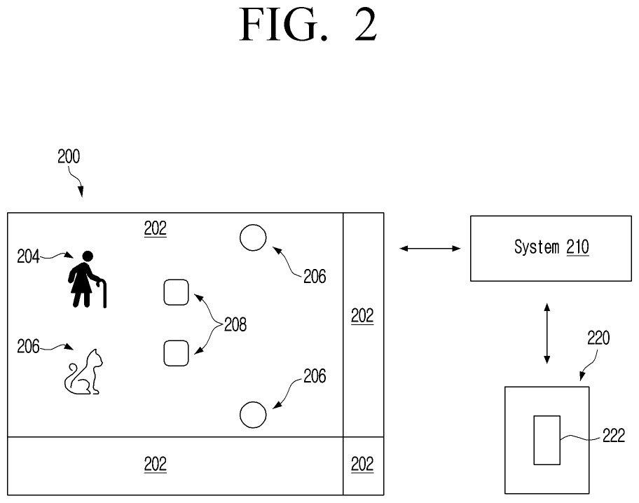

FIG. 2 illustrates an exemplary representation of an Internet of Things (IoT) environment 200. The environment 200 may be associated with a system 210 configured for remote surveillance of the IoT environment 200. In an embodiment, the system 210 may be provided within the IoT environment 200, such as, integrated with one or more elements within the IoT environment 200. In an embodiment, the system 210 may be provided remote to the IoT environment 200, such as, a cloud-based unit. In an embodiment, the system 210 may be provided in a distributed manner where one or more components of the system 210 are provided within the IoT environment 200 and one or more components of the system 210 are provided remote from the IoT environment 200.

The IoT environment 200 may be associated with an area which is to be monitored by a remote user. The IoT environment 200 may be associated with a house, an office, etc. where surveillance is required. The IoT environment 200 may include multiple locations 202 where one or more entities 204 may be present. The multiple locations 202 may include, for instance, living room, bedroom, kitchen area, garage, etc. It is appreciated that the details of the invention may be explained with reference to a location from among the multiple locations 202, however, the details are equally applicable for all locations 202 within the IoT environment 200.

The IoT environment 200 may further include one or more non-imaging sensors 206 and one or more IoT devices 208. The one or more non-imaging sensors 206 may include, as non-limiting examples, motion sensors, audio sensors, light sensors, positioning sensors, etc. The one or more IoT devices 208 may include, as non-limiting examples, television, air-conditioner, lighting units, fridge, etc. In an embodiment, cameras may not form a part of the system 210.

The system 210 may be communicably coupled with a user device 220. The user device 220 may be a user device of a remote user which enables the remote user to perform remote surveillance in conjunction with the system 210. The user device 220 may include a user interface 222 which allows the user to view a visual representation of the location 202 being monitored. The user device 220 may be a mobile phone, a laptop, a computer, a tablet, or any suitable electronic device which can communicate with the system 210. It is appreciated that although a single user device 220 is illustrated in FIG. 2, the system 210 may be connected with multiple user devices as well without departing from the scope of the invention.

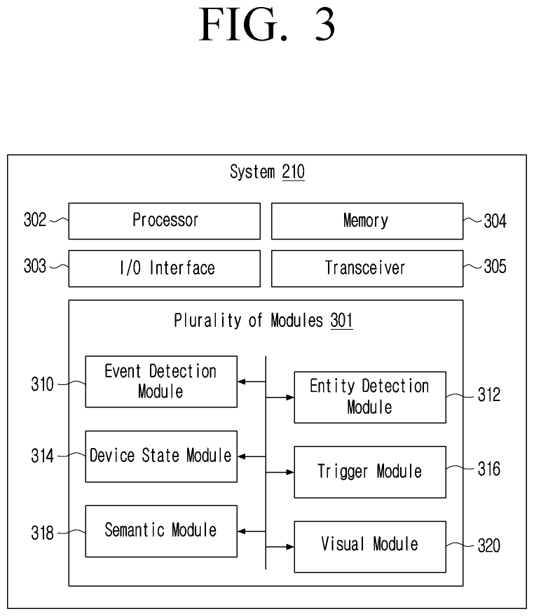

Reference is made to FIG. 3 which illustrates a detailed block diagram of the system 210, according to an embodiment of the present disclosure. The system 210 may include a plurality of modules 301, a processor 302, an Input/Output (I/O) interface 303, a memory 304, and a transceiver 305.

In an exemplary embodiment, the processor 302 may be operatively coupled to each of the I/O interface 303, the plurality of modules 301, the transceiver 305, and the memory 304. In one embodiment, the processor 302 may include a graphical processing unit (GPU) and/or an Artificial Intelligence Engine (AIE). In one embodiment, the processor 302 may include at least one data processor for executing processes in virtual storage area network. The processor 302 may include specialized processing units such as, integrated system (bus) controllers, memory management control units, floating point units, graphics processing units, digital signal processing units, etc. In one embodiment, the processor 302 may include a central processing unit (CPU), a graphics processing unit (GPU), or both. The processor 302 may be one or more general processors, digital signal processors, application-specific integrated circuits, field-programmable gate arrays, servers, networks, digital circuits, analog circuits, combinations thereof, or other now known or later developed devices for analyzing and processing data. The processor 302 may execute a software program, such as code generated manually (i.e., programmed) to perform the desired operation.

The processor 302 may be disposed in communication with one or more input/output (I/O) devices via the I/O interface 303. In some embodiments, the processor 302 may communicate with the user device 220 using the I/O interface 303. The I/O interface 303 may employ near field Communication (NFC), Bluetooth, communication code-division multiple access (CDMA), high-speed packet access (HSPA+), global system for mobile communications (GSM), long-term evolution (LTE), WiMax, or the like, etc.

Using the I/O interface 303, the system 210 may communicate with one or more I/O devices. For example, the input device may be an antenna, microphone, touch screen, touchpad, storage device, transceiver, video device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 302 may be disposed in communication with a communication network via a network interface. In an embodiment, the network interface may be the I/O interface 303. The network interface may connect to the communication network to enable connection of the system 210 with the user devices 220 and/or outside environment. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 210 may communicate with other devices.

In some embodiments, the memory 304 may be communicatively coupled to the processor 302. The memory 304 may be configured to store data and instructions executable by the processor 302. In another embodiment, the memory 304 may be provided via a cloud-based unit. In yet another embodiment, the memory 304 may communicate with the processor 302 via a bus within the system 210. In yet another embodiment, the memory 304 may be located remote from the processor 302 and may be in communication with the processor 302 via a network. The memory 304 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 304 may include a cache or random-access memory for the processor 302. In alternative examples, the memory 304 is separate from the processor 302, such as a cache memory of a processor, the system memory, or other memory. The memory 304 may be an external storage device or database for storing data. The memory 304 may be operable to store instructions executable by the processor 302. The functions, acts or tasks illustrated in the figures or described may be performed by the programmed processor 302 for executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

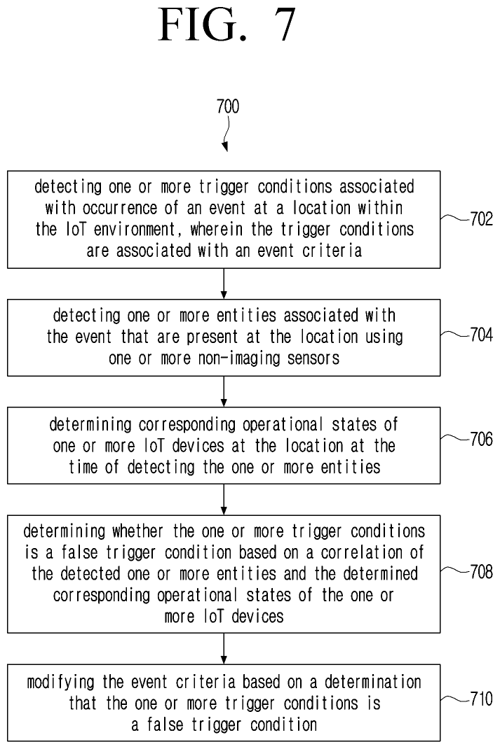

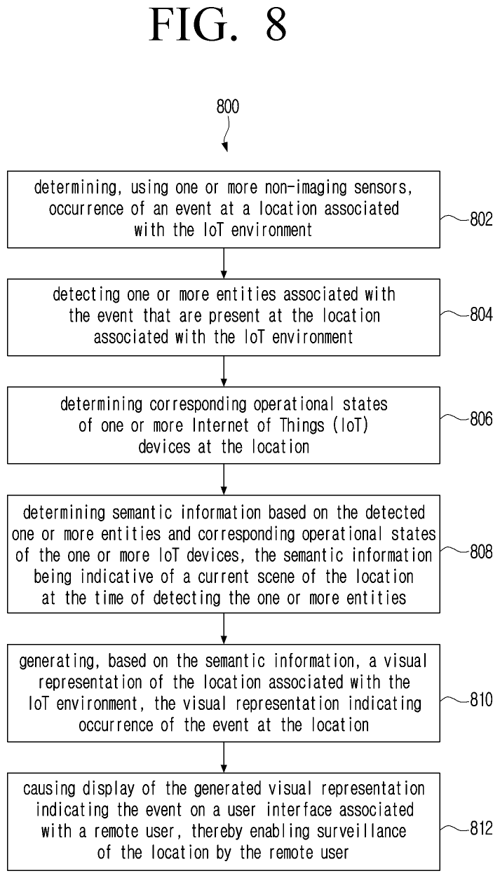

In some embodiments, the plurality of modules 301 may be included within the memory 304. The memory 304 may further include a database to store data. The plurality of modules 301 may include a set of instructions that may be executed to cause the system 210, in particular, the processor 302 of the system 210, to perform any one or more of the methods/processes disclosed herein. The plurality of modules 301 may be configured to perform the steps of the present disclosure using the data stored in the database. For instance, the plurality of modules 301 may be configured to perform the steps disclosed in FIGS. 7-8. In an embodiment, each of the plurality of modules 301 may be a hardware unit which may be outside the memory 304. Further, the memory 304 may include an operating system for performing one or more tasks of the system 210, as performed by a generic operating system.

The transceiver 305 may be configured to receive and/or transmit signals to and from the user devices 220. In one embodiment, the database may be configured to store the information as required by the plurality of modules 301 and the processor 302 to perform one or more functions. Exemplary embodiments are described in detail in FIGS. 7-8.

The plurality of modules 301 may include, but not limited to, an event detection module 310, an entity detection module 312, a device state module 314, a trigger module 316, a semantic module 318, and a visual module 320. The plurality of modules 301 may be implemented by way of suitable hardware and/or software applications.

In some embodiments, at least one of the plurality of modules 301 may use an AI model. A function associated with AI may be performed through the non-volatile memory, the volatile memory, and the processor 302.

The processor 302 may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule stored in the non-volatile memory or may employ a suitable artificial intelligence (AI) model executed from a server or a local memory module.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, active learning and reinforcement learning. The processor 302 may perform pre-processing operations on the data to convert it into a form appropriate for use as an input for the artificial intelligence (AI) model.

Reasoning prediction is a technique of logically reasoning and predicting by determining information and includes, e.g., knowledge-based reasoning, optimization prediction, preference-based planning, or recommendation.

Further, the present disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor 302 or may be a separate component. The communication port may be created in software or may be a physical connection in hardware. The communication port may be configured to connect with a network, external media, the display, or any other components in system, or combinations thereof. The connection with the network may be a physical connection, such as a wired Ethernet connection or may be established wirelessly. Likewise, the additional connections with other components of the system 210 may be physical or may be established wirelessly. The network may alternatively be directly connected to a bus. For the sake of brevity, the architecture and standard operations of the memory 304, the processor 302, the transceiver 305, and the I/O interface 303 are not discussed in detail.

It is appreciated that the details described with reference to the plurality of modules 301 may be performed in conjunction with the processor 302 and the memory 304. The details of the present invention will now be described by collectively referring to FIGS. 2-3.

Initially, one or more entities 204 may be present at the location 202. The one or more entities 204 may include, for instance, an elderly person, a child, a pet, and the like. As an example, a child (entity) may be present in the living room (location). As another example, a cat (entity) may be sitting in the living room (location). As yet another example, an elderly person (entity) may be present in the kitchen (location).

The event detection module 310 may be configured to detect occurrence of the event at the location 202. The event detection module 310 may be configured to detect one or more trigger conditions associated with occurrence of an event at the location 202 within the IoT environment 200. As an example, the event may include an elderly person (entity) falling down in the kitchen (location). As another example, the event may include a cat (entity) playing with a toy in the living room (location). In an embodiment, the event may be detected based on readings from the one or more non-imaging sensors 206.

The one or more trigger conditions may be associated with an event criteria. The event criteria may refer to a predefined criteria which facilitates determination of real and false events so as to avoid raising false alarms. In an embodiment, the event criteria may be a set of dynamic criteria which may be modified based on occurrence of events and associated feedback over a period of time.

The entity detection module 312 may be configured to detect one or more entities 204 associated with the event that are present at the location 202. That is, the entity detection module 312 may be configured to detect which entity is linked to the event that has been detected by the event detection module 310. In an embodiment, the entity detection module 312 may be configured to determine the position of the one or more entities within the location 202.

The entity detection module 312 may be configured to detect the one or more entities based on readings from the one or more non-imaging sensors 206. The entity detection module 312 may be configured to monitor the readings from the one or more non-imaging sensors 206, the readings being associated with the one or more entities 204 that are present at the location 202. The one or more non-imaging sensors 206 may include motion sensor, audio sensors, light sensors, positioning sensors (ultra-wideband) and the like.

The entity detection module 312 may further be configured to determine the actions being performed by the one or more entities 204 based on processing of the monitored readings of the one or more imaging. Considering the example of the elderly person, the actions being performed by the one or more entities 204 may include a sudden movement of the elderly person and/or the elderly person screaming in the kitchen.

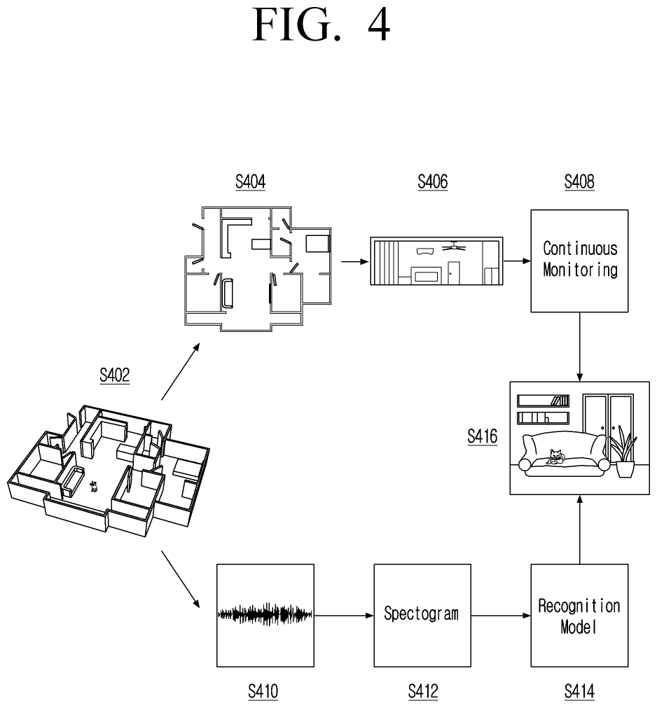

Referring to FIG. 4, a process flow to depict the operation of the entity detection module 312 is illustrated in accordance with an embodiment of the present invention. As seen in FIG. 4, initially at operation S402, occurrence of an event is detected at a particular location, e.g., location 202 within an establishment (for example, a house) based on one or more sensors, e.g., the one or more non-imaging sensors 206. At operation S404, a plurality of motion detection points may be determined based on readings from one or more sensors, e.g., the motion sensor from among the one or more non-imaging sensors 206. Further, at operation S406, an area of interest is determined which may correspond to the location 202. At operation S408, the motion of the one or more entities 204 as well as the change in motion may be monitored continuously. Further, the motion tracking may be performed based on the object size, where the object corresponds to the one or more entities.

In a same or another embodiment, at operation S410, audio data detected by the audio sensor from among the one or more non-imaging sensors, e.g., the one or more non-imaging sensors 206, may be received. At operation S412, the audio data may be processed to determine the audio frequency and to generate the spectrogram for the audio data. In an embodiment, a continuous audio track may be performed with variable window technique on the received audio data in order to generate the spectrogram. At operation S414, the spectrogram output may be passed to a recognition model for processing. The recognition model may be an Artificial Intelligence (AI) model such as a multi-class audio recognition model.

In some embodiments, the operations S404-S408 and the operations S410-S414 may be performed simultaneously. At operation S416, based on the motion tracking at operation S408 and based on an output of the AI model at operation S414, the one or more entities 204 as well as the position of the one or more entities 204 may be detected.

Referring again to FIGS. 2-3, the device state module 314 may be configured to determine the corresponding operational states of the one or more IoT devices 208 present at the location 202. The corresponding operational states refer to the states of the one or more IoT devices 208 at the time of detecting the one or more entities 204 and/or at the time of the occurrence of the event. For example, the device state module 314 may determine that at the location 202 where the one or more entities 204 are detected, the television is switched on, the air-conditioner is switched on, the lights are switched in dim mode, etc.

Further, the trigger module 316 may be configured to determine whether the one or more trigger conditions is a false trigger condition or a real trigger condition. The classification of the one or more trigger conditions as the false trigger condition or the real trigger condition may indicate whether the detected event is a false event or a real event. The false event may refer to an event for which an alert need not be provided to the remote user on the user device 220. The real event may refer to an event for which an alert is required to be generated on the user device 220 of the remote user.

The trigger module 316 may be configured to determine whether the one or more trigger conditions is the false trigger condition based on a correlation of the detected one or more entities 204 and the determined corresponding operational states of the one or more IoT devices 208. In order to determine the correlation, the semantic module 318 may be configured to determine semantic information indicative of a current scene at the location 202 at the time of detecting the one or more entities 204. The current scene refers to the scene at the location 202 when the event has occurred, the scene being defined by the actions of the one or more entities, the operational states of the one or more IoT devices 208, as well as the surroundings and backgrounds at the location 202. As an example, the semantic information for a living room may indicate that the surroundings are well lit, the curtains are opened, the television is on with a news channel, etc.

In some embodiments, the semantic module 318 may generate the semantic information and determine the correlation via an Artificial Intelligence (AI) model. The semantic module 318 may determine parameters associated with the one or more entities 204 and the one or more IoT devices 208 using the AI model. In particular, the semantic module 318 may determine a first set of parameters associated with the one or more entities 204. The first set of parameters may comprise positions of the one or more entities 204, actions being performed by the one or more entities 204, and the like. The semantic module 318 may further determine a second set of parameters associated with the operational state of the one or more IoT devices 208. The second set of parameters may indicate the background scene and surroundings scene at the location 202. Based on the first and second set of parameters, the semantic module 318 may determine the semantic information.

Based on the semantic information, the trigger module 316 may determine whether the one or more trigger conditions are real trigger condition or false trigger condition. In order to determine whether the one or more trigger conditions are real trigger condition or false trigger condition, the trigger module 316 may take into account the readings from the one or more non-imaging sensors 206 as well the sources of the detected events. For instance, considering an event of the elderly person falling down, the audio sensor may detect multiple sounds and the sources of the detected sounds may be sound from television, sound from elderly person, sound from an equipment within the location 202, etc. The trigger module 316 may thus segregate one or more sources of the detected event based on the readings from the one or more non-imaging sensors 206.

Further, the trigger module 316 may determine a confidence score associated with each of the segregated one or more sources. The confidence score may be determined based on one or more AI models. Considering the example of the elderly person falling down, the trigger module 316 may determine that the confidence score for the sound from television is five percent, the confidence score for the sound from the home equipment is two percent, and the confidence score for the sound for a person falling is ninety percent.

Once the confidence scores are determined, the trigger module 316 may compare the determined confidence scores with a pre-determined threshold. The pre-determined threshold may be stored in the memory 304. Based on the comparison, the trigger module 316 may determine the one or more trigger conditions to be real trigger condition or false trigger condition. As mentioned previously, the classification of the one or more trigger conditions as the false trigger condition or the real trigger condition may indicate whether the detected event is a false event or a real event. Accordingly, the trigger module 316 may further classify the detected event as a false event or a real event based on the comparison of the confidence scores with the pre-determined threshold.

When the trigger module 316 determines the one or more trigger conditions to be false trigger condition, the trigger module 316 may be configured to modify the modify the event criteria. The modification may be considered as feedback for dynamically updating the event criteria which enables more and more accurate event detection over a period of time. Accordingly, the trigger module 316 prevents false alarms.

As an example, a cat (entity) may be playing with a toy in the living room (location). The motion sensor may detect an event (motion of the cat). The state of the IoT devices 208 and the semantic information may be determined. Further, the trigger module 316 may determine that the confidence score for the sound from television is eighty percent and confidence score from the positioning sensor is ninety-five percent. Based on the confidence scores, the trigger module 316 may determine that the event is a false event and proceed to update the event criteria. Based on the modifications in the event criteria, the accuracy and efficiency of the system 210 is improved. For instance, the same event may not be considered as a trigger and further computation is avoided.

When the trigger module 316 determines the one or more trigger conditions to be real trigger condition, i.e., the event is determined as the real event, further processing is performed. The visual module 320 may be configured to generate a visual representation of the location 202 based on the semantic information generated by the semantic module 318. The visual representation may indicate the occurrence of the event at the location 202. In an embodiment, the visual representation may include representations of the one or more entities 204, the one or more IoT devices 208 in their operational states, and the surroundings of the location 202.

In an embodiment, the visual module 320 may determine one or more ground images based on the semantic information. The ground images may correspond to the one or more entities 204 and the current scene at the location 202. In particular, the ground images may be sample images which may be stored in the memory 304. For instance, an image for the location 202 may be available based on the physical map of the location 202. Further, sample images for the one or more entities 204 may be available. Thus, the ground images may be considered to generate the visual representation.

In an embodiment, the visual representation is a static image or a set of static images. In an embodiment, the visual representation may be a sequence of frames that are generated based on the semantic information. The sequence of frames may be based on a current scene at the location 202. For instance, the operational states of the one or more devices 208 and the actions of the one or more entities 204 may be depicted. Thus, a continuous visual representation of the location 202 may be generated.

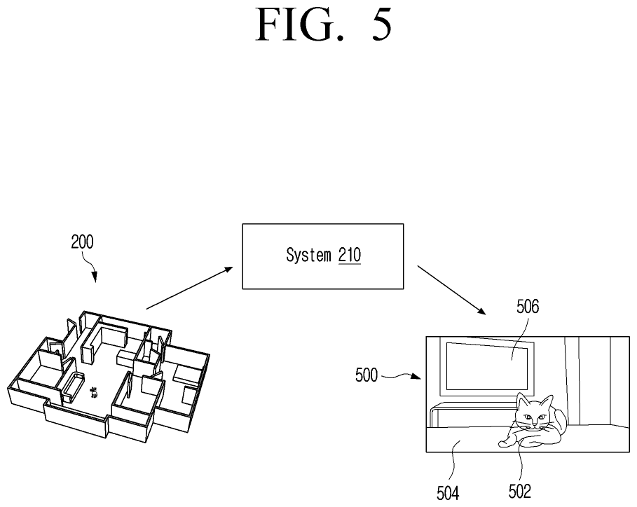

Referring to FIG. 5, an example of the visual representation is illustrated. In the example of FIG. 5, the system 210 may detect motion of a cat (entity) within the bedroom of the IoT environment 200. The system 210 may detect the cat, and further, detect the operational states of the IoT devices as well as the scene at the location. The system 210 may detect the cat meowing near a bed. Further, the system 210 may detect that the television is switched ON, the lightings are blue color, and the blinds are OFF. Based on the semantic information, the visual representation 500 may be generated. As seen in the visual representation 500, an avatar 502 of the cat may be shown near the bed 504. Further, the television 506 may be shown as switched ON and the blinds may be shown as switched OFF. Moreover, the lighting at the location may be shown in blue color. The visual representation thus represents the current scene at the location where the one or more entities (here, the cat) may be detected.

In an embodiment, the visual module 320 may remove sensitive information associated with the one or more entities 204. In some embodiments, privacy rules may be pre-defined and stored in the memory 304. In an embodiment, the privacy rules may be defined by the remote user. Based on the pre-defined privacy rules, the semantic information may be updated such that privacy of the one or more entities 204 is not breached.

In some embodiments, the semantic module 318 may be configured to detect a semantic change condition associated with the semantic information. The semantic change may be a result of the pre-defined privacy rules which causes a change in the semantic information to remove sensitive information associated with the one or more entities 204. That is, the semantic information may be updated by the semantic module 318 based on the detected semantic change condition. The semantic change condition may thus include a removal and/or a modification of a unit, such as sensitive information, from the semantic information. Further, the visual representation may be generated by the visual module 320 based on the updated semantic information. For example, an avatar for the one or more entities 204 may be used in the visual representation. Thus, privacy of the one or more entities is not breached. In an embodiment, U-Net may be utilized to generate the visual representation based on the semantic information.

The visual module 320 may be configured to cause display of the generated visual representation indicating the event on the user interface 222 associated with the user device 220 of the remote user. For instance, the visual module 320 may transmit the generated visual representation to the user device 220 such that the visual representation is displayed on the user interface 222. As mentioned previously, the visual representation may be a sequence of frames of the location. As a result, surveillance of the location by the remote user is enabled.

In some embodiments, the system 210 may enable remote surveillance in a secure manner as all the processing may happen on an edge unit or cloud unit with end-to-end encryption. In some embodiments, the remote user may provide access to a limited number of locations within the IoT environment to avoid privacy breaches. For instance, the remote user may allow surveillance only for living room and kitchen.

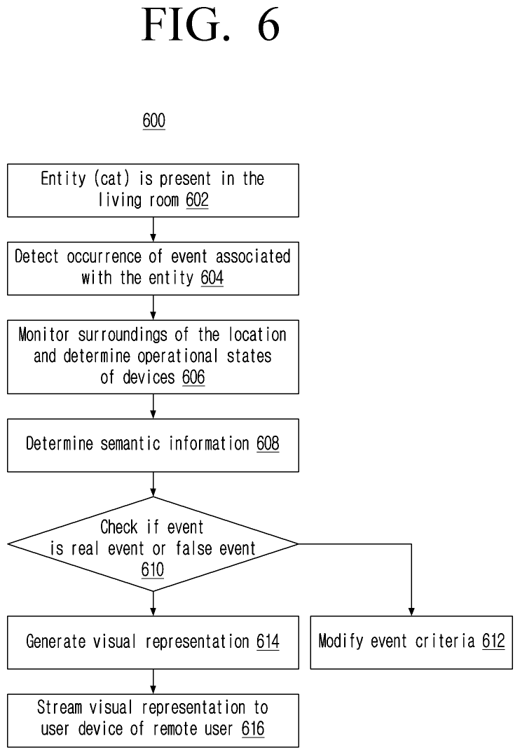

Referring to FIG. 6, an exemplary operational flow 600 associated with remote surveillance of the IoT environment 200 is depicted. The operations of FIG. 6 may be performed by the system 210, in particular, the processor 302 and the modules 301 of the system 210, but the disclosure is not limited thereto.

At operation 602, an entity is present in a place in a location, for example, a cat, is present in the living room and the cat meows in the living room near a sofa. At operation 604, the one or more non-imaging sensors detect the occurrence of an event associated with the entity, for example, cat. In an illustrated embodiment, the audio sensor detects the meowing of the cat at the location.

At operation 606, the surroundings of the location are monitored. That is, the operational states of the IoT devices are determined and the current scene (surroundings) at the location is determined. At operation 608, the semantic information for the current scene at the location is determined. The semantic information may be generated based on correlation of the detected entity (e.g., cat) and operational states of the one or more IoT devices at the location.

At operation 610, the system 210 checks whether the event is a real event or a false event. The determination may be based on the trigger conditions being classified as real trigger condition or false trigger condition. In case the event is a false event, the process does not proceed further and event criteria to detect the event may be modified at operation 612. In case the event is a real event, the visual representation may be generated at operation 614. The visual representation may indicate the current scene at the location and may be annotated with augmented information. In some embodiments, as described above, privacy rules may be used to generate the visual representation. The visual representation depicts the semantic information at the location in order to provide accurate surveillance data to the remote user. At operation 616, the generated visual representation may be streamed to the remote user via the user device 220. In an embodiment, the visual representation may be encrypted prior to sending to the user device 220. In an embodiment, a notification and/or a sequence of frames may be shown to the remote user. The remote user can thus monitor the entity at the location.

FIG. 7 illustrates an exemplary process flow 700 for remote surveillance in an IoT environment, according to an embodiment of the present disclosure. In one embodiment, the steps of the method 700 may be performed by the system 210, for instance, by the processor 302 of the system 210 in conjunction with the plurality of modules 301 and the memory 304, but the disclosure is not limited thereto.

At operation 702, one or more trigger conditions associated with occurrence of an event at a location within the IoT environment are triggered, wherein the trigger conditions are associated with an event criteria.

At operation 704, the exemplary process flow 700 includes detecting one or more entities associated with the event that are present at the location using one or more non-imaging sensors.

At operation 706, the exemplary process flow 700 includes determining corresponding operational states of one or more IoT devices at the location at the time of detecting the one or more entities.

At operation 708, the exemplary process flow 700 includes determining whether the one or more trigger conditions is a false trigger condition based on a correlation of the detected one or more entities and the determined corresponding operational states of the one or more IoT devices. In some embodiments, the exemplary process flow 700 may include correlating the one or more entities and the corresponding operational states of the one or more IoT devices by determining semantic information indicative of the current scene of the location at the time of detecting the one or more entities. In an embodiment, the semantic information may be generated using a generative AI model.

At operation 710, the exemplary process flow 700 includes modifying the event criteria based on a determination that the one or more trigger conditions is a false trigger condition.

FIG. 8 illustrates an exemplary process flow 800 for remote surveillance in an IoT environment, according to another embodiment of the present disclosure. In one embodiment, the steps of the method 800 may be performed by the system 210, for instance, by the processor 302 of the system 210 in conjunction with the plurality of modules 301 and the memory 304, but the disclosure is not limited thereto.

At operation 802, the exemplary process flow 800 includes determining, using one or more non-imaging sensors, occurrence of an event at a location associated with the IoT environment.

At operation 804, the exemplary process flow 800 includes detecting one or more entities associated with the event that are present at the location associated with the IoT environment.

At operation 806, the exemplary process flow 800 includes determining corresponding operational states of one or more Internet of Things (IoT) devices at the location.

At operation 808, the exemplary process flow 800 includes determining semantic information based on the detected one or more entities and corresponding operational states of the one or more IoT devices, the semantic information being indicative of a current scene of the location at the time of detecting the one or more entities.

At operation 810, the exemplary process flow 800 includes generating, based on the semantic information, a visual representation of the location associated with the IoT environment, the visual representation indicating occurrence of the event at the location.

At operation 812, the exemplary process flow 800 includes causing display of the generated visual representation indicating the event on a user interface associated with a remote user, thereby enabling surveillance of the location by the remote user.

While the above discussed steps in FIGS. 7-8 are shown and described in a particular sequence, the steps may occur in variations to the sequence in accordance with various embodiments. Further, a detailed description related to the various steps of FIGS. 7-8 is already covered in the description related to FIGS. 2-6 and is omitted herein for the sake of brevity.

In an exemplary use case, an elderly person and a pet may be in the house of a user. The user may have left the house for work. The house may not have cameras installed for surveillance. In the living room, a fall event may be detected via sensors integrated with speaker and watch in the living room. The fall event may be detected as the elderly person may have fallen down in the living room. In related techniques, a static notification may be sent to the remote user and the user may not be sure if the fall detection is for the elderly person or some other object has fallen down. However, in methods and systems disclosed herein, the system detects that the event is not a fake event and proceeds to generate the visual representation of the elderly person falling down along with operational states of the IoT devices. The remote user may thus be fully aware of the event and can take informed decisions.

In another exemplary use case, a child may be alone in the house and the user may have left the house for work. The house may not have cameras installed for surveillance. The child may be playing with a toy in the living room. Motion may be detected via presence sensors integrated with television. In related techniques, a static notification may be sent to the remote user and the user may not be sure if what the child is doing. However, in methods and systems disclosed herein, the system detects that the event is a fake event, in that, the child is not in danger or distress. As a result, the system does not trigger a notification to the remote user. Fake alarm is thus prevented.

In yet another exemplary use case, the user may have left the house for some work. The house may be empty and no one may be at the house. A motion may be detected at the backyard of the house. In related techniques, a static notification may be sent to the remote user and the user may not be sure what is happening in the backyard. However, in methods and systems disclosed herein, the system detects the motion and generates a visual representation of the backyard having the detected entities and surroundings. The remote user may view the visual representation to get some context on the detected motion. As a result, user engagement is increased and potential intrusions are prevented.

In other exemplary use cases, water flowing sound may be detected by speakers in the house. The system may detect that there is water leakage in the house and may decide to alert the remote user regarding the leakage. A visual representation can then be generated to show the scene at the location (for instance, using ground images and house map details). The remote user can thus be alerted and informed decisions can be made.

The present disclosure provides for various technical advancements based on the key features discussed above. The presently disclosed methods and systems enable smart surveillance of various locations. Locations where cameras are not installed can be monitored in an accurate and efficient manner. Further, embodiments of the present disclosure reduce the number of false alarms since the remote user is not alerted for each and every event. Rather, the systems and methods update the event criteria to detect false events and thereby prevent false alerts. In other words, false alarm causing conditions can be detected by correlating the entities and operational state of IoT devices and subsequently reducing the number of false alarms. User engagement is thus improved with significant reduction in false alarm rates.

Additionally, remote users can have a visualization of the event that has been detected in a particular location. An intuitive representation of the location is shown to the user. For instance, user can get a near real time representation of AI generated content of the location. Thus, the systems and methods allow remote users to get a continuous, reliable visualization for events and the associated entities at the locations being monitored, and particularly those locations which are not covered by cameras. Further, the alerts and notifications being sent to the remote user have meaningful motion images and videos rather than static notifications without any context. Moreover, privacy of the entities being monitored can also be maintained using pre-defined privacy rules.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for remote surveillance in an Internet of Things environment, the method comprising:
detecting one or more trigger conditions associated with occurrence of an event at a location within the IoT environment, wherein the one or more trigger conditions are associated with an event criteria;
detecting one or more entities associated with the event that are present at the location using one or more non-imaging sensors;
determining operational states of one or more IoT devices at the location at a time of detecting the one or more entities;
determining whether the one or more trigger conditions is a false trigger condition based on a correlation of the one or more entities and the operational states of the one or more IoT devices; and
modifying the event criteria based on a determination that the one or more trigger conditions is the false trigger condition.

2. The method as claimed in claim 1, comprising:
correlating the one or more entities and the operational states of the one or more IoT devices by determining, using an Artificial Intelligence (AI) model, semantic information indicative of a current scene of the location at the time of detecting the one or more entities.

3. The method as claimed in claim 2, wherein determining whether the one or more trigger conditions is the false trigger condition comprises:
segregating one or more sources of the event using the one or more non-imaging sensors;
determining, based on the AI model, confidence scores, wherein a confidence score is associated with each of the segregated one or more sources;
comparing the confidence scores with a pre-determined threshold; and
classifying the one or more trigger conditions to be false or real based on the comparison.

4. The method as claimed in claim 2, comprising:
determining the one or more trigger conditions to be a real trigger condition;
generating, based on the semantic information, a virtual visual representation of the location within with the IoT environment upon the determination that the one or more trigger conditions is the real trigger condition, the virtual visual representation indicating the occurrence of the event at the location; and
causing display of the virtual visual representation on a user interface associated with a remote user.

5. The method as claimed in claim 2, wherein determining the semantic information comprises:
determining a first set of parameters associated with the one or more entities, wherein the first set of parameters comprises at least one of a position of the one or more entities and an action being performed by the one or more entities;
determining a second set of parameters associated with the operational states of the one or more IoT devices, wherein the second set of parameters are indicative of a background scene and surrounding scene at the location; and
determining the semantic information based on the first set of parameters and the second set of parameters.

6. The method as claimed in claim 4, wherein generating the virtual visual representation comprises:
detecting a semantic change condition associated with the semantic information based on a plurality of pre-defined privacy rules;
updating the semantic information based on the semantic change condition, wherein the semantic change condition is associated with at least one of a removal of a unit from the semantic information or a modification of the unit from the semantic information; and
generating the virtual visual representation of the location based on the updated semantic information.

7. The method as claimed in claim 1, wherein the detecting the one or more entities comprises detecting actions being performed by the one or more entities using the one or more non-imaging sensors, wherein the one or more non-imaging sensors include at least one of a motion sensor and an audio sensor.

8. The method as claimed in claim 4, wherein generating the virtual visual representation of the location comprises generating a sequence of frames based on the semantic information.

9. A system for remote surveillance in an Internet of Things (IoT) environment, the system comprising:
memory;
at least one processor communicably coupled to the memory, the at least one processor being configured to:
detect one or more trigger conditions associated with occurrence of an event at a location within the IoT environment, wherein the one or more trigger conditions are associated with an event criteria;
detect one or more entities associated with the event that are present at the location using one or more non-imaging sensors;
determine operational states of one or more IoT devices at the location at a time of detecting the one or more entities;
determine whether the one or more trigger conditions is a false trigger condition based on a correlation of the one or more entities and the operational states of the one or more IoT devices; and
modify the event criteria based on a determination that the one or more trigger conditions is the false trigger condition.

10. The system as claimed in claim 9, wherein the at least one processor is configured to:
correlate the one or more entities and the operational states of the one or more IoT devices by determining, using an Artificial Intelligence (AI) model, semantic information indicative of a current scene of the location at the time of detecting the one or more entities.

11. The system as claimed in claim 10, wherein to determine whether the one or more trigger conditions is the false trigger condition, the at least one processor is configured to:
segregate one or more sources of the event using the one or more non-imaging sensors;
determine, based on the AI model, confidence scores, wherein a confidence score is associated with each of the segregated one or more sources;
compare the confidence scores with a pre-determined threshold; and
classify the one or more trigger conditions to be false or real based on the comparison.

12. The system as claimed in claim 10, wherein the at least one processor is configured to:
determine the one or more trigger conditions to be a real trigger condition;
generate, based on the semantic information, a virtual visual representation of the location within with the IoT environment upon the determination that the one or more trigger conditions is the real trigger condition, the virtual visual representation indicating the occurrence of the event at the location; and
cause display of the virtual visual representation on a user interface associated with a remote user.

13. The system as claimed in claim 10, wherein to determine the semantic information, the at least one processor is configured to:
determine a first set of parameters associated with the one or more entities, wherein the first set of parameters comprises at least one of a position of the one or more entities and an action being performed by the one or more entities;
determine a second set of parameters associated with the operational states of the one or more IoT devices, wherein the second set of parameters are indicative of a background scene and surroundings scene at the location; and
determine the semantic information based on the first set of parameters and the second set of parameters.

14. The system as claimed in claim 12, wherein to generate the virtual visual representation, the at least one processor is configured to:
detect a semantic change condition associated with the semantic information based on a plurality of pre-defined privacy rules;
update the semantic information based on the semantic change condition, wherein the semantic change condition is associated with at least one of a removal of a unit from the semantic information or a modification of the unit from the semantic information; and
generate the virtual visual representation of the location based on the updated semantic information.

15. The system as claimed in claim 9, wherein the detecting the one or more entities comprises detecting actions being performed by the one or more entities using the one or more non-imaging sensors, wherein the one or more non-imaging sensors include at least one of a motion sensor and an audio sensor.

16. A non-transitory computer readable medium storing instructions, the instructions causing at least one processor to:
detect one or more trigger conditions associated with occurrence of an event at a location within the IoT environment, wherein the one or more trigger conditions are associated with an event criteria;
detect one or more entities associated with the event that are present at the location using one or more non-imaging sensors;
determine operational states of one or more IoT devices at the location at a time of detecting the one or more entities;
determine whether the one or more trigger conditions is a false trigger condition or a real trigger condition based on a correlation of the one or more entities and the operational states of the one or more IoT devices; and
based on a determination that the one or more trigger conditions is the real trigger condition, generate a virtual visual representation of the location within with the IoT environment, the virtual visual representation graphically indicating the occurrence of the event at the location.

17. The non-transitory computer readable medium of claim 16, wherein the instructions further cause the at least one processor to:
cause display of the virtual visual representation on a user interface associated with a remote user; and
wherein the generating the virtual visual representation is based on semantic information indicative of a current scene of the location at the time of detecting the one or more entities.

18. The non-transitory computer readable medium of claim 17, wherein generating the virtual visual representation comprises:
detecting a semantic change condition associated with the semantic information based on a plurality of pre-defined privacy rules;
updating the semantic information based on the semantic change condition, wherein the semantic change condition is associated with at least one of a removal of a unit from the semantic information or a modification of the unit from the semantic information; and
generating the virtual visual representation of the location based on the updated semantic information.

19. The non-transitory computer readable medium of claim 16, wherein the instructions further cause the at least one processor to:
modify the event criteria based on the determination that the one or more trigger conditions is the false trigger condition.

20. The non-transitory computer readable medium of claim 18, wherein determining whether the one or more trigger conditions is the false trigger condition comprises:
segregating one or more sources of the event using the one or more non-imaging sensors;
determining, based on the AI model, confidence scores, wherein a confidence score is associated with each of the segregated one or more sources;
comparing the confidence scores with a pre-determined threshold; and
classifying the one or more trigger conditions to be false or real based on the comparison.
